(19) United States
(12) Patent Application Publication
(10) Pub. No.: US 2005/0235548 A1
(43) Pub. Date: Oct. 27, 2005

(54) Railing mounted rod holder

(76) Inventors: Darryl Barron, Raleigh, NC (US); George H. Blaisdell JR., Siler City, NC (US)

Correspondence Address: MERCHANT & GOULD PC, P.O. BOX 2903, MINNEAPOLIS, MN, 55402-0903, US

(21) Appl. No.: 11/110,357

(22) Filed: Apr. 20, 2005

Related U.S. Application Data
(60) Provisional application No. 60/564,034, filed on Apr. 21, 2004.

(51) Int. Cl. A01K 97/10

(52) U.S. Cl. 43/21.2; 43/54.1

(57) ABSTRACT

The invention relates to a boat accessory for maximizing usable deck space. In particular, the boat accessory attaches to a boat railing and includes a fishing rod holder, a table, and a coupler. The fishing rod holder is attached to the table and the table is attached to the coupler, which mounts the table to the boat railing.

### CROSS REFERENCE TO RELATED APPLICATIONS

This application claims the benefit of U.S. Provisional Patent Application Ser. No. 60/564,034 filed Apr. 21, 2004, which application is hereby incorporated by reference in its entirety.

### TECHNICAL FIELD

The present invention relates generally a boat accessory. More particularly, the present invention relates to fishing rod holders for boats.

### BACKGROUND OF THE INVENTION

Improvements have been made in boats to enhance useable deck space. Accordingly, a number of fishing rod holding systems have been developed for promoting the efficient use of space in a boat. For example, U.S. Pat. No. 4,671,009 and 6,101,966 both disclose systems for holding fishing rods and other fishing accessories such as tackle. Nonetheless, other systems for promoting the effective use of deck space in a boat are needed.

### SUMMARY OF THE INVENTION

One aspect of the present invention relates to a rod holder that mounts to a railing for a boat that promotes more efficient use of deck space.

Another aspect of the present invention relates to a table that mounts to a railing of a boat and provides a work surface and a fishing rod holder.

Examples of a variety of aspects in addition to those described above are set forth in the description that follows. It is to be understood that both the foregoing general description and the following detailed description are exemplary and explanatory only and are not restrictive of the broad inventive aspects that underlie the examples disclosed herein.

### BRIEF DESCRIPTION OF THE DRAWINGS

FIG. 1 is a top plan view of a boat having an example boat accessory attached thereto in accordance with the principles of the present disclosure;

FIG. 2 is a perspective view of FIG. 1 from above the boat accessory;

FIG. 3 is a perspective view of FIG. 1 with a fishing rod located in one of the rod holders;

FIG. 4 is a perspective view of FIG. 1 from below the boat accessory;

FIG. 5 is a cross-sectional view of the boat accessory of FIG. 1 attached to the boat; and

FIG. 6 is a perspective view of an alternative embodiment of the boat accessory railing coupler in accordance with the principles of the present invention.

### DETAILED DESCRIPTION

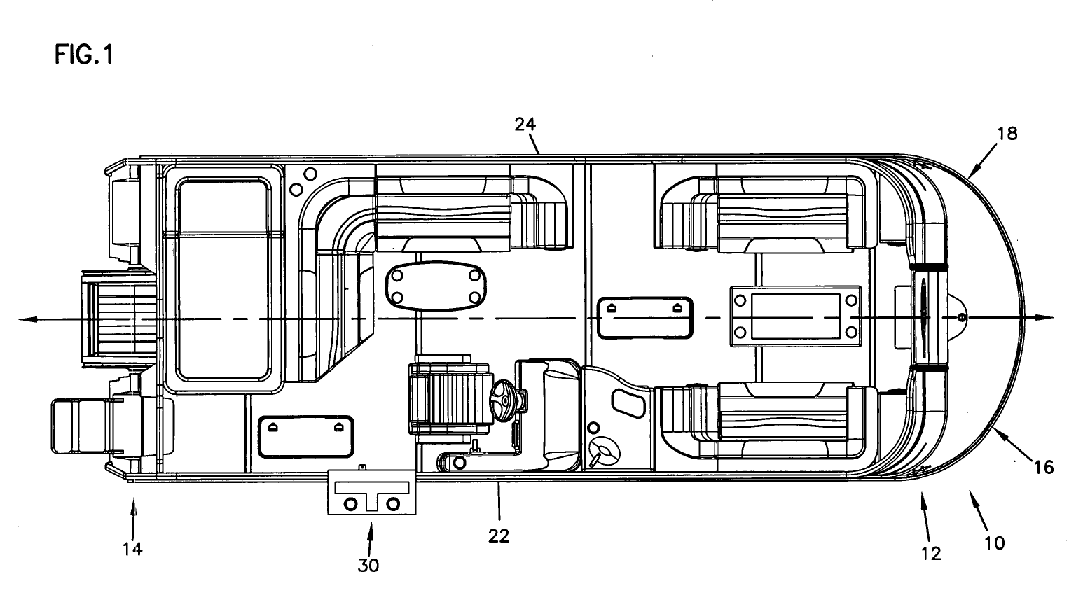

FIG. 1 illustrates a boat 10 having features that are examples of inventive aspects in accordance with the principles of the present disclosure. The boat includes a bow 12, a stern 14, a port side 18, a port railing 24, a starboard side 16, and starboard railing 22. The boat further includes a boat accessory 30 attached to the starboard railing 22. It should be appreciated that though FIG. 1 shows the boat accessory 30 attached along the starboard railing 22, the boat accessory 30 is adapted to be attached anywhere along the railing of the boat 10.

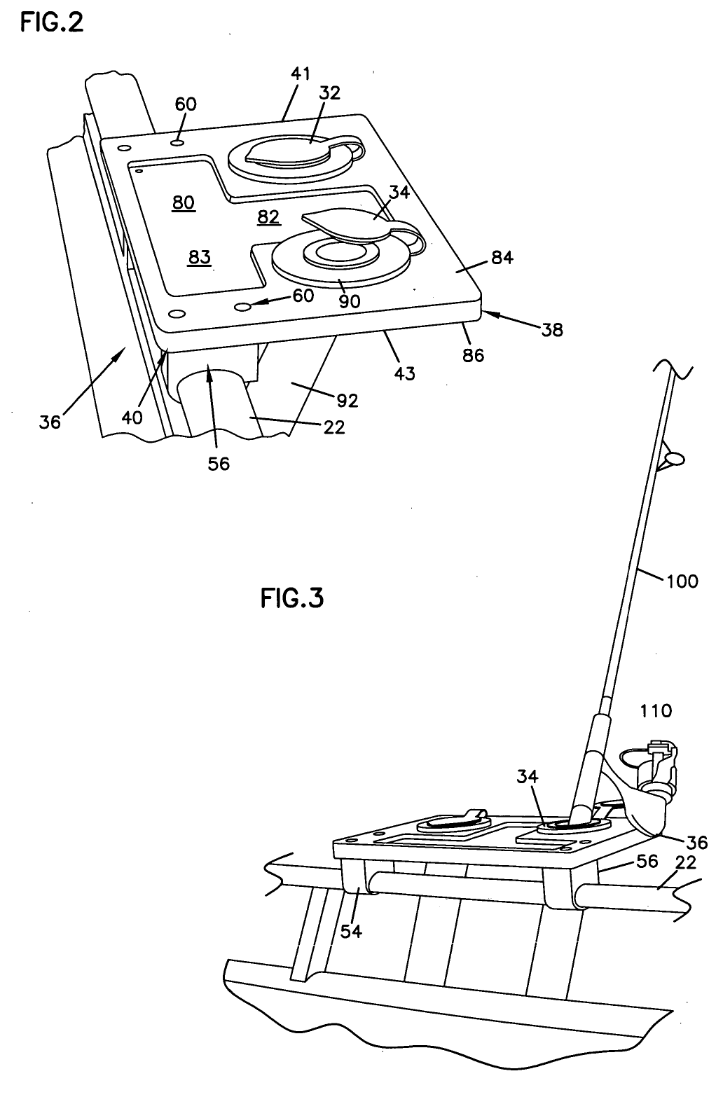

Referring to FIG. 2, a perspective view of the boat 10 including the boat accessory 30 is shown from a viewing position above the boating accessory 30. The boating accessory 30 depicted, includes a generally rectangular table 36 that has two oppositely positioned major sides 38, 40 and two oppositely positioned minor sides 41, 43. The table 36 can be many other shapes other than a rectangle; for example, an elliptical shape, a circular shape or any other shape may be used. As shown, table 36 overhangs the railing 22 with the major side 40 positioned nearest the boat 10, and the major side 38 positioned furthest from the boat 10.

Referring still to FIG. 2, the boating accessory 30 includes a first rod holder 32 and a second rod holder 34 that are shown mounted near the major side 38 of the table 36. However, it should be appreciated that the rod holders 32, 34 can be mounted anywhere on the table 36. In addition, any number of rod holders can be mounted to the table 36.

In the embodiment shown in FIG. 2, the rod holders 32 and 34 include a flange portion 90 and a sleeve portion 92. The flange portion 90 flush mounts to the table 36 via fasteners such as screws. The sleeve portion 92 extends below the table 36 at an oblique angle relative to the table 36 back towards the boat 10. In certain embodiments, the sleeve portions 92 can be abutted against the boat 10 to provide auxiliary support to free end of the table 36. The rod holder may be, for example, a 30° Flush Mount Rod Holder available though Whitecap Industries, Inc. (www.whitecapindustries.net) under part number S-096B/617.

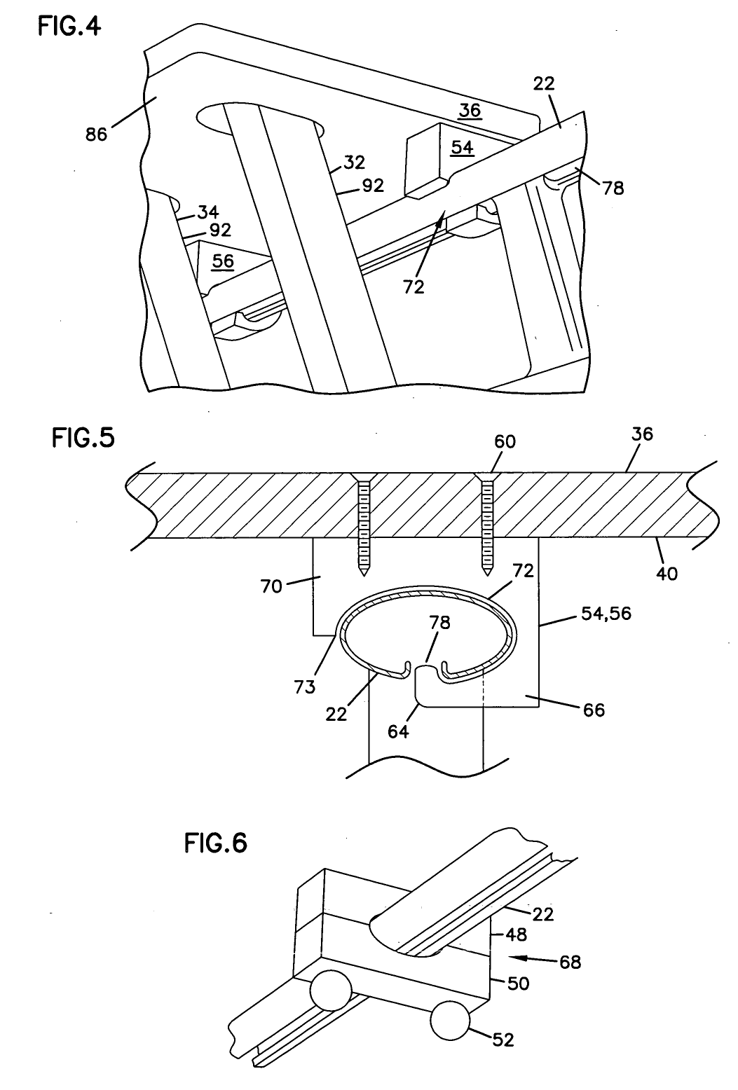

Still referring to FIG. 2, the table 36 includes a top surface 84 and a bottom surface 86 (see FIG. 4). The top surface 84 includes a recessed portion 80. In the embodiment depicted, the recessed portion 80 is T-shaped with a first part 82 of the T-shaped recess portion 80 disposed between the rod holders 32, 34 and a second portion 83 that extends along the side 40 of the table 36. As shown in FIG. 2, the first part 82 has a length that extends away from the boat 10 and the second part 83 has a length that extends along the railing 22. The recess portion 80 provides a tray-like working surface that prevents objects from easily rolling off of the table 36 when the boat 10 moves. It should be appreciated that alternatively the entire top surface 84 of the table 36 less the periphery edges could be recessed thereby defining a raised edge or lip around the table 36.

Referring to FIG. 3, a perspective view of FIG. 1 with a fishing rod 100 located in the second rod holder 34 is shown. The fishing rod 100 includes a handle 110 having a butt end that is inserted into the sleeve 92 of the rod holder 34 and thereby secured.

As shown in FIG. 3, the boat accessory 30 is attached to the starboard railing 22 by two railing couplers 54 and 56. The railing couplers 54 and 56 each include an opening 72 (see FIG. 5) for receiving the railing 22. The opening 72 is shaped to match the contour of the railing 22. In the depicted embodiment, the railing 22 has an elliptical cross section and has slot 78 on the bottom side. Thus, the shape of the opening 72 defined by the railing couplers 54 and 56 is preferably generally elliptical to conform to and engage the outer surface of the railing 22.

Referring still to FIG. 5, the railing couplers 54 and 56 each include an inner arm 66 and an outer arm 70. A gap 73 is defined between the ends of the inner and outer arms 66, 70. The inner arm 66 includes a protrusion 64 that is sized to be received by the slot 78 at the underside of the railing 22. The railing couplers 54 and 56 are sized such that the inner surface of the railing couplers 54 and 56 frictionally engage the outer surface of the railing 22. The configuration is such that when weight is applied to the table 36, the inner surface of the railing couplers 54 and 56 lock in a cam-like fashion against the railing 22 and prevent the table 36 from falling off the railing 22. Though the figures depicts that the table 36 includes two railing couplers 54 and 56. The table 36 may include any number of railing couplers 54 and 56.

In use, the table 36 is fastened to the railing 22 by manipulating the table 36 such that the couplers 54, 56 hook over the railing 22 causing the railing 22 to slide into the opening 72 of the couplers 54, 56 through the gap 73. This fastening process continues until the protrusion 64 moves into the slot 78 and a secure connection is provided between the table 36 and the railing 22. In certain embodiments, the arms 66 can flex during the insertion process such that the protrusions 64 snap into the slot 78.

It should be appreciated that the boat railing 22 can have many different cross-sectional geometric configurations. For example, rather than an elliptical cross section, the railing 22 can include rectangular or circular cross sections or any number of other shapes. In addition, the railing 22 may include no slot on the underside. Therefore, the exact configuration of the railing couplers 54, 56 depends largely on the particular configuration of the railing 22 and is not limited to the configurations shown. As used herein, the term “railing couplers” includes any devices or structures capable of securing/coupling a table to a boat railing.

The railing couplers 54 and 56 are shown to be connected to the table via fasteners 60. The fasteners 60 can be any conventional fasteners including bolts, screws, etc. Additionally, it should be appreciated that the railing couplers 54 and 56 can be glued to the table 36 or secured by way of interference keyways fits, snap fits, or other means. Moreover, the railing couplers 54 and 56 could be manufactured integrally with the table via a machining or molding process.

The table 36 and railing couplers 54 and 56 shown in the figures are manufactured from a plastic moldable material. However, it should be appreciated that the table 36 can be manufacture from other material such as, wood, metal, or fiberglass. The particular material chosen could depend on aesthetic as well as cost factors.

Referring to FIG. 6, an alternative embodiment of a railing coupler 68 is shown. The railing coupler includes a first portion 50 that engages the underside of the railing 22 and a second portion 48 that engages the topside of the railing 22. The first and second portions 50 and 48 each include a cutout that match the general cross-sectional profile of the railing 22. The first portion 50 is connected to the second portion 48 by fasteners 52. The railing coupler 68 is constructed such that when the fasteners 52 are tightened, the first portion 50 and the second portion 48 of the railing coupler 68 securely clamp onto the railing 22 and prevent relative movement between the railing coupler 68 and the railing 22.

The railing coupler 68 is attached to the bottom surface 80 of the table 36 via conventional fastening means (glue, screws, bolts, etc.). Alternative the second portion 48 of the railing coupler 68 can be formed integral with the table 36.

In the depicted embodiment, the railing couplers 68, 54, and 56 are attached adjacent the major side 40 of the table 36 such that the table projects outwardly from the boat 10. This orientation maximizes useable deck space since the table 36 is cantilevered over the edge of the boat 10. However, it should be appreciated that the couplers 68, 54, and 56 can be mounted anywhere on the table 36. For example, it may be desirable to mount the couplers 68, 54, and 56 near the center portion of the table 36 or elsewhere.

With regard to the forgoing description, changes may be made in detail, especially with regard to the shape, size, and arrangement of the parts. It is intended that the specification and depicted aspects be considered as illustrative only and not limiting with respect to the broad underlying concepts of the present disclosure.

The above specification, examples and data provide a complete description of the manufacture and use of the composition of the invention. Since many embodiments of the invention can be made without departing from the spirit and scope of the invention, the invention resides in the claims hereinafter appended.

1. A boat accessory for attachment to a boat railing comprising:
a table;
a first rod holder attached to the table; and
a first railing coupler attached to the table for coupling the table to the boat railing.

2. The boat accessory according to claim 1, wherein first railing coupler is positioned such that the table is adapted to cantilever outwardly from the boat railing when installed on the boat railing.

3. The boat accessory according to claim 1, wherein the first railing coupler includes a partially elliptical cross section constructed to snap onto the boat railing.

4. The boat accessory according to claim 1, wherein the first railing coupler comprises a clamp.

5. The boat accessory according to claim 1, wherein the first railing coupler is bolted to the table.

6. The boat accessory according to claim 1, wherein the first railing coupler includes:
a first portion constructed to engage an underside of the boat railing;
a second portion constructed to engage a top side of the boat railing and the bottom surface of the table; and
fasteners adapted to attach the first portion of the coupler to the second portion of the coupler, and second portion of the coupler to the table.

7. The boat accessory according to claim 1, further comprising a second railing coupler attached to the table and constructed to engage the boat railing.

8. The boat accessory according to claim 1, further comprising a second rod holder attached to the table.

9. The boat accessory according to claim 1, wherein a top surface of the table includes a recessed portion.

10. The boat accessory according to claim 9, wherein the recessed portion includes a T-shape.

11. The boat accessory according to claim 10, wherein a base of the T-shaped recess extends between the first and a second rod holder.

12. The boat accessory according to claim 1, wherein the table comprises a plastic construction.

13. The boat accessory according to claim 1, wherein the table comprises a moldable material.

14. The boat accessory for according to claim 1, wherein the table comprises a generally rectangular shape.

15. A boat comprising:
a deck having a railing;
a table mounted to the railing; and
at least one rod holder attached to the table for supporting a fishing rod.

16. The boat according to claim 15, wherein the table is positioned such that the table is adapted to cantilever outwardly from the boat railing when installed on the boat railing.

17. The boat according to claim 15, wherein the railing includes a partial elliptical cross section.

18. The boat according to claim 15, wherein the table is snapped onto the railing.

19. The boat according to claim 15, wherein the table is clamped to the railing.

20. The boat with a table mounted rod holder according to claim 15, further comprising at least two rod holders attached to the table.

21. The boat according to claim 15, wherein a top surface of the table includes a recessed portion.

22. The boat according to claim 21, wherein the recessed portion includes a T-shape.

23. The boat according to claim 22, wherein the base of the T-shaped recess extends between the first and a second rod holder

24. The boat according to claim 15, wherein the table comprises a plastic construction.

25. The boat according to claim 15, wherein the table comprises a moldable material.

26. The boat according to claim 15, wherein the table comprise a generally rectangular shape.
